(19) United States
(12) Patent Application Publication
(10) Pub. No.: US 2024/0392579 A1
(43) Pub. Date: Nov. 28, 2024

(54) CARBON SEQUESTERING INFRASTRUCTURE

(71) Applicant: Rowan University, Glassboro, NJ (US)

(72) Inventor: Islam M. Mantawy, Glassboro, NJ (US)

(21) Appl. No.: 18/673,512

(22) Filed: May 24, 2024

Related U.S. Application Data
(60) Provisional application No. 63/468,810, filed on May 25, 2023.

(51) Int. Cl. E04F 13/14; B01D 53/62; B33Y 70/00; B33Y 80/00

(52) U.S. Cl. CPC E04F 13/141; B01D 53/62; B33Y 70/00; B33Y 80/00; B01D 2221/16; B01D 2251/95; B01D 2257/504

(57) ABSTRACT

Carbon sequestering infrastructure incorporates carbon-sequestering cladding members that are separate and distinct from structural elements configured to carry a structural load of the infrastructure. The cladding is capable of capturing and sequestering carbon from carbon dioxide in atmospheric/ambient air. The cladding may be distinct members having a high carbon capture capacity (but a low compressive strength unsuitable for use in a structural member) attached to structural members having a lower carbon capture capacity (and a higher compressive strength suitable for use in a structural member). The cladding member may be formed as an envelope suitable for use as a form in casting a structural member. Infrastructure elements including cladding may be configured such that the cladding is removable and replaceable after is carbon sequestering capacity is diminished, to allow for carbon sequestration over the entire length of the infrastructure.

### CROSS-REFERENCE TO RELATED APPLICATION

This application claims the benefit of priority, under 35 U.S.C. § 119 (e), of U.S. Provisional Patent Application No. 63/468,810, filed May 25, 2023, the entire disclosure of which is hereby incorporated herein by reference.

### FIELD OF THE INVENTION

The present invention relates generally to buildings, bridges, culverts, towers, barriers, and other structures exposed to atmospheric air, and more particularly, to carbon-sequestering cladding that can be added to or used in the construction of infrastructure elements for infrastructure structures to provide carbon-sequestering infrastructure capable of extracting, capturing and storing carbon (e.g., from carbon dioxide) from atmospheric/ambient air to which the infrastructure is exposed.

### DISCUSSION OF RELATED ART

Greenhouse gas (GHG) emissions, e.g., in the form of carbon dioxide, released into atmospheric air are posing environmental and/or climate change threats and challenges. Therefore, it is generally desirable to reduce the amount of carbon dioxide in atmospheric air.

Construction, maintenance, and rehabilitation activities account for 28% of the transportation sector's GHG emissions. Emissions arise both from the production of raw materials as well as from the vehicle-based transportation of materials throughout the entire manufacturing and construction process, many of which burn carbon-based fuels and product carbon dioxide emissions.

It has been considered desirable to produce materials and structures with a relatively-low carbon footprint. Recently, researchers have been developing construction materials with lower carbon impact, such as concrete mixes with supplementary cementitious materials (SCMs) that fully or partially replace hydraulic cement. These SCMs are typically made from industrial waste such as silica fume (a byproduct of silicon and ferrosilicon industry), fly ash (byproduct of coal industry), and slag (byproduct of iron industry). However, these materials have not yet been widely implemented due to low acceptance of the technology.

To date efforts at reducing carbon dioxide in this context have largely involved the development of materials with either low embodied carbon or materials incorporating bio-organisms (bacteria) that can sequester CO2 from the atmosphere. However, these conventional approaches have proven to be unsatisfactory for use of these use of these materials to build load-bearing structural elements in real-world infrastructure construction applications due to the lower compressive strength of these materials that hindered the use as structural concrete.

What is needed is an approach to construction, maintenance and/or rehabilitation activities that can reduce the amount of carbon dioxide in atmospheric air.

### SUMMARY

The present invention relates generally to construction and/or maintenance techniques application to buildings, bridges, culverts and other structures exposed to atmospheric/ambient air (collectively referred to broadly herein as “infrastructure” and/or “infrastructure structures”), and more particularly to infrastructure that incorporates carbon-sequestering cladding members capable of capturing and sequestering carbon from carbon dioxide in atmospheric/ambient air, thereby reducing the amount of carbon dioxide in atmospheric air.

More particularly, the present invention provides carbon-sequestering cladding members that can be permanently incorporated into infrastructure elements. Further, the present invention provides removable/replaceable carbon-sequestering cladding members that can be added to existing infrastructure, removable/replaceable carbon-sequestering cladding members that can be configured to partially cover or completely encase infrastructure elements, and removable/replaceable carbon-sequestering cladding elements in the nature of envelopes that can be used as forms to cast concrete in the construction of concrete elements of infrastructure.

Construction methods in relation to such carbon-sequestering cladding members and infrastructure elements are provided also. For example, novel infrastructure structures (e.g., bridges, etc.) may be constructed using infrastructure elements manufactured in accordance with the present invention. For example, an exemplary method may involve forming (e.g., 3D printing/additive manufacturing of a replaceable envelope cladding elements) collectively suitable for serving as a concrete casting form that is made of a material enabling carbon sequestration from atmospheric air (e.g., in substitution for traditional wood or steel formwork), assembling the cladding elements into a form suitable for use in casting an infrastructure's structural member configured to bear a structural load, casting (pouring/curing) concrete in the assembled cladding envelope to form a structural member, the structural member and envelope cladding member in combination providing an infrastructure element, and constructing infrastructure to include the infrastructure element (the structural member and the cladding member made of carbon sequestering material).

Further, an exemplary method includes waiting until the carbon sequestration capacity of the cladding member is diminished, disassembling the infrastructure element to separate the original cladding member from the structural member, and reassembling the infrastructure element by mounting a replacement cladding member to the structural member, the replacement cladding member having a carbon sequestration capacity currently greater than that of the original cladding member, due to the original cladding members' sequestration of carbon from ambient air over time.

By way of example, the concrete mix material used to form the structural member may be concrete designed to have a low embodied carbon and have a low carbon footprint, e.g., concrete with high percentage of cement replacement (silica fume, fly ash, slag), bio-polymer concrete, and geopolymer concrete. In this manner, the infrastructure remains load bearing and structurally sound at all times, but the carbon sequestration material of the cladding may be replaced after its carbon sequestration capacity has been reduced, to restore the carbon sequestration capacity of the infrastructure.

Accordingly, the present invention can be used to help transition to zero carbon, or carbon-negative, infrastructure.

### BRIEF DESCRIPTION OF THE FIGURES

An understanding of the following description will be facilitated by reference to the attached drawings, in which:

FIG. 1 is a perspective view of an exemplary bridge, including carbon sequestering infrastructure elements, in accordance with an exemplary embodiment of the present invention;

FIGS. 2A, 2B and 2C are perspective, cross-sectional, and perspective views, respectively, of exemplary girder-type, column-type and cap beam-type infrastructure elements, each comprising a structural member enveloped in a respective carbon-sequestering cladding member, in accordance with an exemplary embodiment of the present invention;

FIG. 3 is a perspective view of exemplary replaceable envelope cladding member elements for a cap beam-type structural member in accordance with an exemplary embodiment of the present invention;

FIG. 4 is a perspective view of the cladding member elements of FIG. 3 partially assembled into a cladding member suitable for use as a form for casting of a structural member, in accordance with an exemplary embodiment of the present invention;

FIG. 5 is a perspective view of exemplary replaceable envelope cladding member elements of FIG. 3 fully assembled into a cladding member usable as a form for casting of a structural member, in accordance with an exemplary embodiment of the present invention;

FIG. 6 is a perspective view of the form of FIG. 5 being used to cast a structural member, in accordance with an exemplary embodiment of the present invention;

FIG. 7 is an infrastructure element after the casting shown in FIG. 6, in accordance with an exemplary embodiment of the present invention;

FIG. 8 is a cross-sectional view of the infrastructure element of FIG. 7, taken along line A-A′;

FIG. 9 shows the infrastructure element of FIG. 7 partially disassembled, in accordance with an exemplary embodiment of the present invention, to remove the original cladding member after it has a diminished carbon sequestration capacity;

FIG. 10 shows a reassembled infrastructure element similar to that of FIG. 7 but including replacement a cladding member having a higher carbon sequestration capacity than the original cladding members, in accordance with an exemplary embodiment of the present invention;

FIG. 11 is a flow diagram illustrating an exemplary method for use of carbon sequestration construction elements in infrastructure construction;

FIG. 12 is a perspective view of exemplary cladding elements for a column-type structural member in accordance with an exemplary embodiment of the present invention;

FIG. 13 is a perspective view of the exemplary cladding elements of FIG. 12, shown partial assembled into a cladding member for a column-type structural member in accordance with an exemplary embodiment of the present invention;

FIG. 14 is an exploded perspective view of an infrastructure element including the exemplary cladding elements of FIG. 12 and a structural element, in accordance with an exemplary embodiment of the present invention; and

FIG. 15 is a perspective view showing exemplary cladding members partially covering a structural member of bridge infrastructure;

FIG. 16A is a perspective view of an exemplary 3D-printed cladding member that has been cut into cladding member elements;

FIG. 16B is a perspective view of the exemplary 3D-printed cladding elements of FIG. 16A assembled into a cladding member; and

FIG. 17 is a perspective view showing exemplary 3D-printed cladding members assembled to form a cladding member.

### DETAILED DESCRIPTION

The present invention provides novel structural and non-structural construction elements for use in the construction of infrastructure systems/structures. The elements include carbon sequestering cladding made of carbon sequestering material. In certain embodiments, an infrastructure element for infrastructure construction includes a load-bearing structural member and an integrated carbon-sequestering cladding member, which may be in the form of an envelope, encasement, or cladding. The cladding member may be configured to be removable and replaceable with respect to the structural member. In this manner, the present invention provides carbon-sequestering construction materials and methods providing for capture/sequestration of carbon dioxide from the atmosphere/ambient air, to help provide active zero-carbon and/or carbon-negative infrastructure, especially in instances in which structurally-sound low-embodied-carbon concrete or other construction materials, e.g., concrete with high percentage of cement replacement (silica fume, fly ash, slag), bio-polymer concrete, and geopolymer concrete, are used to construct the carbon-sequestering cladding members and/or the structural members of the infrastructure elements. By way of example, low-embodied-carbon concrete may have a carbon content in a range of about 300 kgCO2 eq to about 600 kgCO2 eq, whereas conventional concrete may have a carbon content in a range of about 100 kgCO2 eq to about 300 kgCO2 eq.

The infrastructure elements emulate existing structural members from a load-bearing perspective and are suitable for use in substitution for conventional infrastructure construction elements, particularly those made of concrete, such as bridge girders, bridge columns, and bridge cap beams, among others. However, infrastructure elements in accordance with the present invention are preferably made to include a structural member of concrete material (e.g., with low embodied carbon), and cladding made of a carbon sequestering material, such as concrete including carbon sequestering bacteria and/or bio-organisms.

The cladding may be permanently attached to the structural members. However, because the structural members have a relatively long service life, and the cladding material/bacteria/bio-organisms have a relatively short service life, at least with respect to carbon sequestration capacity, the infrastructure elements may be constructed such that the cladding members are readily removable from the structural elements so as to be readily replaceable, such that aged cladding with diminished sequestration capacity may be replaced with new cladding with greater sequestration capacity, over the life of the infrastructure, such that the carbon sequestration ability of the infrastructure may be renewed over time.

Optionally, cladding materials that have reached or neared their carbon sequestration capacity may be crushed and reused in infrastructure projects. For example, such crushed materials are suitable for use as aggregates in any infrastructure project because the absorbed/sequestered carbon has enhanced their mineralization such that they are suitable for such use.

Accordingly, the carbon-sequestering construction elements and construction methods of the present invention are capable of greatly reducing carbon emissions due to the transportation infrastructure, and allow for reducing of carbon emission from construction materials; enabling infrastructure to sequester CO2 from the atmosphere, using of replaceable cladding and/or envelopes that sequester CO2 and enable CO2 from atmosphere throughout the entire life of the infrastructure; reducing health issues for the public due to construction emissions; and fighting of climate change.

The present invention is discussed below in the context of a bridge-type infrastructure structure for illustrative purposes only. It should be appreciated that the present invention may be used to construct any type of infrastructure structure exposed to atmospheric/ambient air.

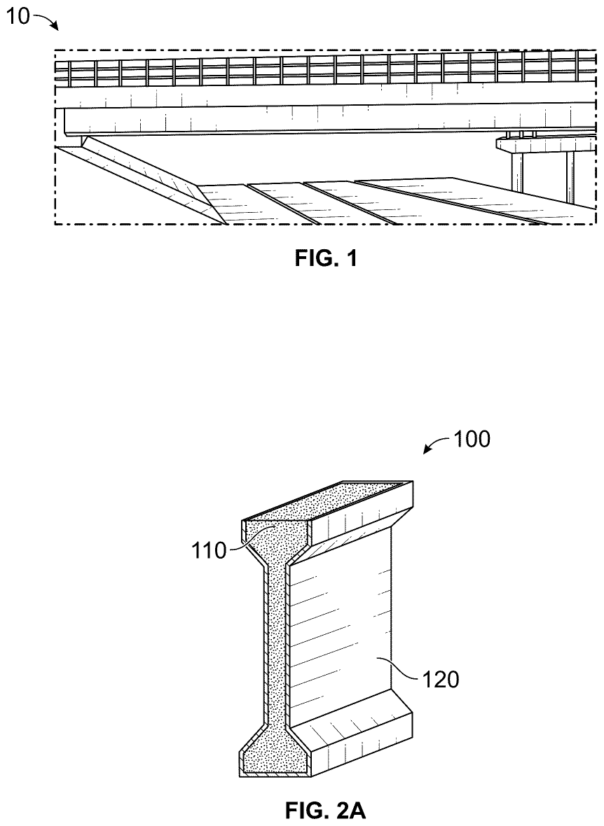

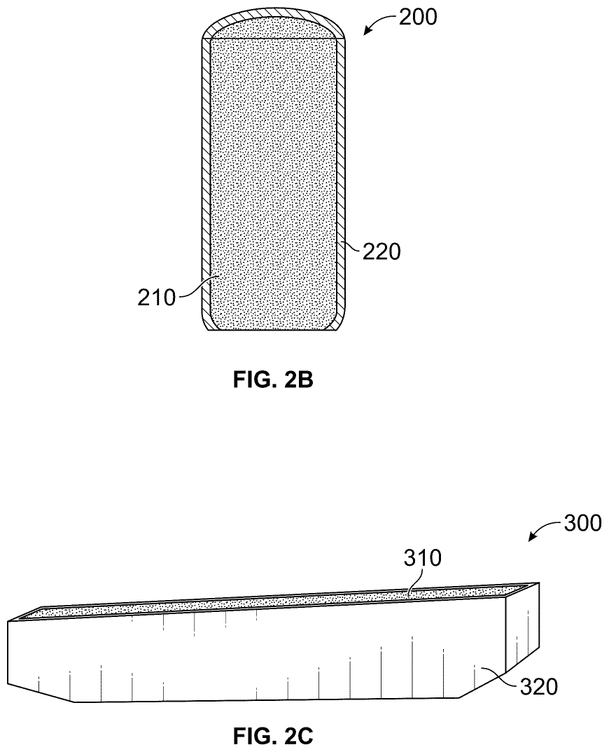

Referring now to FIGS. 1 and 2A-2C, FIG. 1 is a perspective view of an exemplary bridge 10 in accordance with the present invention. The exemplary bridge 10 is similar to conventional bridges in that it includes bridge girders, bridge columns, and bridge cap beams, which may be formed of concrete as is typical in conventional bridge construction.

Unlike conventional bridges, the exemplary bridge 10 includes carbon-sequestering infrastructure elements used in the construction of the infrastructure structure. Accordingly, in this example, the bridge girders 100, bridge columns 200, and bridge cap beams 300 are configured as carbon-sequestering infrastructure elements in accordance with the present invention, as shown in FIGS. 2A-2C. Notably, the bridge girder 100, bridge column 200, and bridge cap beam 300 infrastructure elements may be designed and constructed to act as structural elements for carrying any desired structural loads according to the needs of the infrastructure structure, design elements, etc., and accordingly, the infrastructure elements in accordance with the present invention may be used as direct substitutes for corresponding structural elements used in conventional construction techniques.

More particularly, consistent with the present invention, each of the girder-type, column-type and cap beam-type infrastructure elements 100, 200, 300 comprises a structural member 110, 210, 310, respectively, and a respective cladding member 120, 220, 320, respectively, as shown in FIGS. 2A-2C.

Each structural member 110, 210, 310 is constructed of a load-bearing material suitable for carrying a desired structural load as part of the infrastructure structure. For example, each structural member 110, 210, 310, may be shaped and dimensioned to bear the desired structural load based on the material used, as well known in the art for infrastructure design and construction. Accordingly, for example, each structural member 110, 210, 310 may be constructed of a concrete material having an average compressive strength of in a range of about 5,000 psi to about 22,000 psi, for example, as generally known in the construction field.

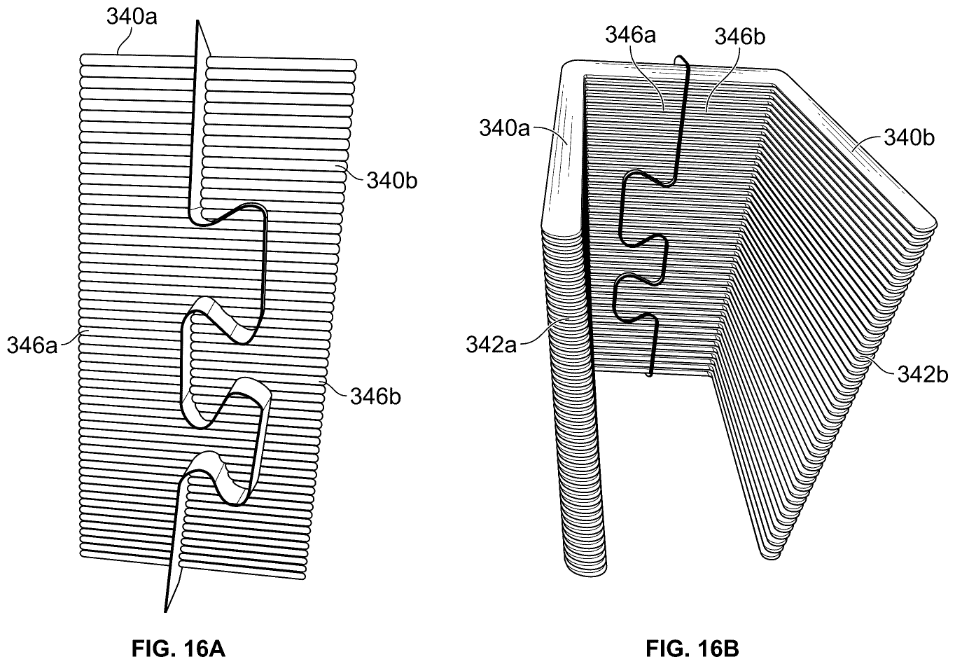

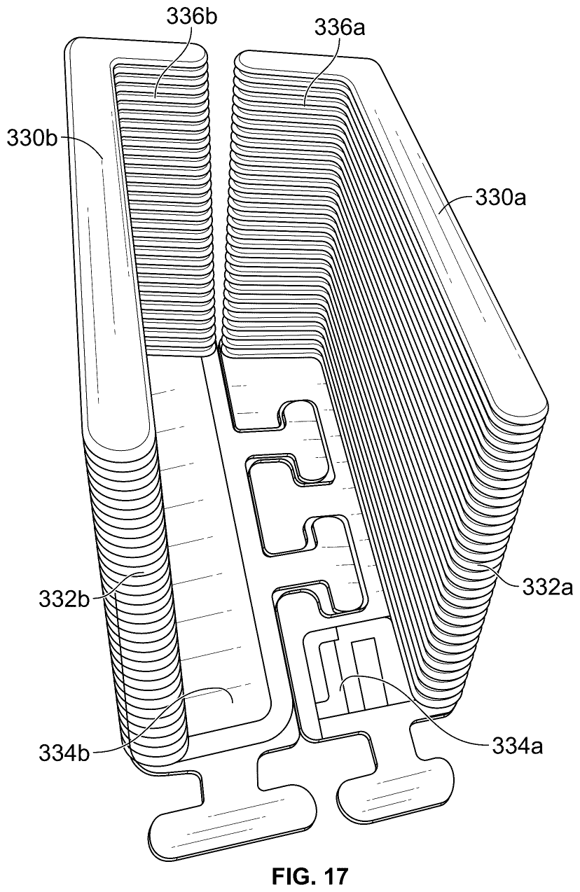

In certain embodiments, the cladding elements may be constructed using an additive manufacturing technique, such as 3D-printing of a concrete mix. For example, an exemplary method may involve forming (e.g., 3D printing/additive manufacturing) of replaceable carbon-sequestering cladding elements using a material enabling carbon sequestration from atmospheric air. FIG. 16A is a perspective view of an exemplary 3D-printed cladding member 340 that has been cut into cladding member elements 340a, 340b. FIG. 16B is a perspective view of the exemplary 3D-printed cladding elements of FIG. 16A assembled into the cladding member. FIG. 17 is a perspective view showing exemplary 3D-printed cladding members 330a, 330b assembled to form a cladding member.

In accordance with one embodiment of the present invention, the structural member may be constructed of a low-carbon-embodied concrete, e.g., concrete having a high percentage of cement replacement (silica fume, fly ash, slag), bio-polymer concrete, and geopolymer concrete. In this manner, the carbon dioxide production associated with production of the structural member may be less relative to other conventional concrete materials. This can help to contribute to structures in accordance with the present invention being net zero-carbon to net negative-carbon infrastructures, as discussed further herein.

In accordance with the present invention, each cladding member 120, 220, 320, is supported on a respective structural member 110, 210, 310, but is not designed to be a load-bearing member for bearing a structural load as part of the infrastructure structure. Accordingly, each cladding member need not be constructed of a material suitable for load-bearing purposes. Rather, each cladding member 120, 22, 320 is constructed of a material configured to sequester carbon from ambient air contacting the cladding member, e.g., such as atmospheric air after the infrastructure structure has been erected/constructed and is in service.

By way of example, each cladding member 120, 200, 320 may be constructed of a material configured to sequester carbon that comprises bacteria or bio-organisms operative to sequester carbon from air contacting the material. Such bacteria and bio-organisms and their use to sequester carbon are well-known in the art. By way of example, Bacillus sphaericus grown in urea and yeast extract at 20 g/l of the solution is bacteria suitable for this purpose. By way of examples, concrete mix preparations may be prepared to include such bacteria and bio-organisms, as known in the art. Generally speaking, internal porosity in the concrete allows the bacteria to absorb carbon dioxide/capture carbon in the presence of humidity, and store the captured carbon in the pores.

However, concrete mixes including having low embodied carbon and/or including such bacteria and/or bio-organisms suitable for sequestering carbon generally have an average compressive strength in a range of about 1,500 psi to about 2,000 psi, which is significantly less that what is required of a load-bearing material in many infrastructure structure applications. However, the present invention combines such concrete as a non-structural cladding member with a structurally-sounds structural member constructed of a suitable load-bearing material to provide structurally sound structures capable of carbon sequestration.

In certain embodiments, the cladding member may be permanently bonded to the structural member—e.g., by casting them together, bonding with adhesive, attaching with non-removable mechanical fasteners to couple them together (e.g., rebar), etc. In this case of an infrastructure element including a permanently attached/not readily removable/replaceable (i.e., without significant effort or damage) cladding member, the infrastructure element may be placed into service, and its cladding member will serve to sequester carbon in the cladding material as a result of the cladding members/infrastructure elements' contact with ambient air. This will continue for the life of the structure, or more likely, for the life of the bacteria and/or bio-organisms of the cladding member, or until the carbon sequestration capacity of the cladding member is depleted or so diminished as to be effectively depleted. At such a point, the infrastructure element may have sequestered an advantageous amount of carbon, but because the carbon sequestering capacity is likely to last for a period shorter than the service life of the infrastructure, the infrastructure elements are likely to cease sequestering of additional carbon at a point in time prior to the end of service life of the infrastructure structure.

In certain other embodiments, the cladding member may be removably attached to the structural member—e.g., by forming the cladding member and the structural member as distinctly different structures, and then releasably joining them together such that the cladding member is not permanently attached but rather is readily removable/replaceable (i.e., without significant effort or damage) relative to the cladding member. For example, this may be achieved by way of removable mechanical fasteners (e.g., threaded bolts/anchors in the structural member and complementary nuts). In this case of an infrastructure element including a cladding member may be placed into service, and its cladding member will serve to sequester carbon in the cladding material as a result of the cladding member's/infrastructure element's contact with ambient air. This will continue for the life of the bacteria and/or bio-organisms of the cladding member, or until the carbon sequestration capacity of the cladding member is depleted or so diminished as to be undesirably low. At such a point, the infrastructure element's carbon sequestration capacity may be removed by removing the cladding having the diminished carbon sequestration capacity from the structural member, e.g., by removing the removable fasteners, and a replacement cladding member with a higher carbon sequestration capacity may be attached to the structural member in its place. This construction/maintenance approach also for carbon sequestration by the infrastructure structure for a period longer period that could be achieved by a single set of carbon sequestering cladding, thereby enabling robust carbon sequestration for the entire service life of the infrastructure structure.

It will be appreciated that, for a given carbon-sequestering material, a larger cladding member having a greater surface area of carbon-sequestering material will generally provide a faster rate of carbon sequestration, and an overall higher carbon sequestration capacity. Accordingly, in certain embodiments, the cladding member may be configured as an encasement to fully encapsulate the entire surface area of the structural member, or at least the entire surface area of the structural member that will be exposed to atmospheric after assembly of the infrastructure structure, to provide for a relatively high level of carbon sequestration. By way of example, this may be a suitable construction approach for applying a cladding member to an existing structure, e.g., by spraying a coating of cladding material onto an existing structure, although other approaches may be used.

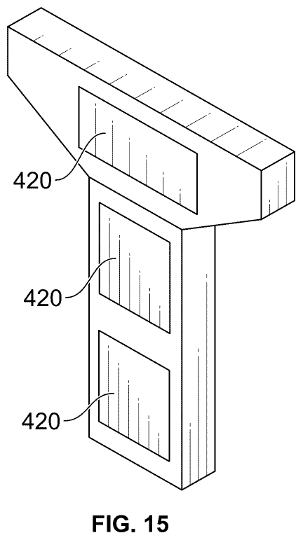

In other embodiments, the cladding member may be configured as a shell to no more than partially cover the entire surface area of the structural member. In this case, the surface area of the cladding member may be relatively less, but the disadvantage of an overall lesser surface area per infrastructure structure may be outweighed by the ease of mounting such cladding to a greater number of infrastructure structures, such that overall, a higher degree of carbon sequestration is provided across many structures. By way of example, this may be a suitable construction approach for apply a cladding member to an existing structure, e.g., by attaching discrete panels, such as uniform panels or a set of standardized sized/shaped panels that are suitable for mounting to a wide variety of instances of infrastructure structures. By way of illustrative example, FIG. 15 is a perspective view showing exemplary cladding members 420 in the nature of discrete panels partially covering a structural member of bridge infrastructure.

In a certain embodiment, the cladding member may be constructed as a set of cooperative cladding elements that are assemblable to collectively form a single cladding member for a structural member. Such cladding elements may include uniform/standardized elements having standardized sizes/shapes, and/or of custom-designed elements having non-standardized sizes/shapes, or a combination thereof. In certain such embodiments, the cladding elements of a set of cooperative cladding elements may be configured with complementary female and male, or other, mating structures to facilitate registration, mating and/or fastening of one cladding element to another. For example, the complementary structures may be configured to mechanically interlock adjacent cladding members with an interference fit. In other embodiments, mechanical fasteners or other means may be used to join cladding elements to each other to form the cladding member.

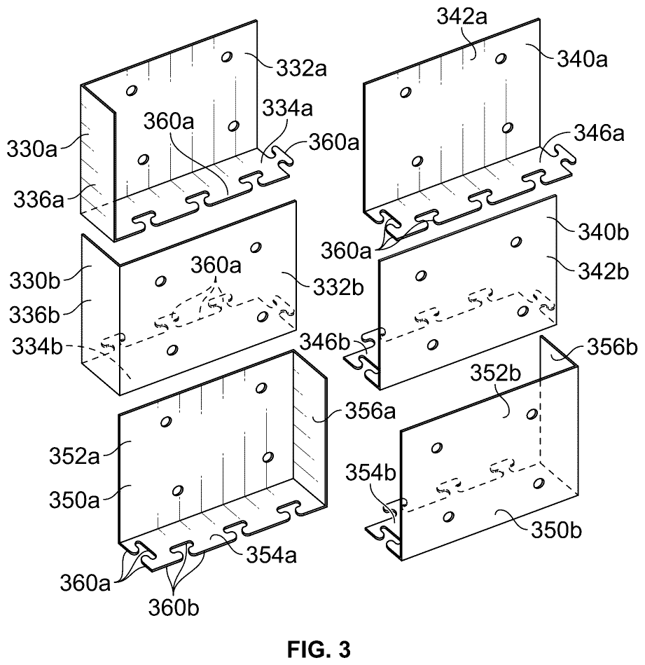

In another embodiment, the cladding member may be configured as an envelope to define a partially closed form, somewhat analogous to a conventional open-top or open-ended concrete form, suitable for casting concrete to form a desired structural member. FIGS. 3-5 show an exemplary replaceable envelope cladding elements assemblable into an exemplary cladding member 320 usable as a form to cast an exemplary cap beam-type structural member 310 to form a cap beam-type infrastructure member 300 in accordance with an exemplary embodiment of the present invention. It will be appreciated that this example in the context of a cap beam-type structural member is for illustrative purposes only, and non-limiting.

It will be appreciated that any existing structural element must be confirmed to have sufficient remaining load-bearing capacity to support the addition load of any added cladding, and that any new structural element being designed should be designed to have sufficient load-bearing capacity to support the primary infrastructure and the intended associated cladding.

Some conventional concrete may naturally sequester carbon dioxide/carbon at a very low rate, but this is generally disadvantageous to the infrastructure, since the resulting carbonation causes corrosion of steel in the infrastructure. It should be noted that the cladding covering concrete of the structural member acts as a membrane that prevents contact of covered portion of the structural member with ambient air, and thus prevents carbon from penetrating/carbonating the structural member in those covered areas, which is advantageous.

Referring now to FIG. 3, exemplary replaceable envelope cladding elements 330a, 330b, 340a, 340b, and 350a, 350b are shown. In this example, the cladding elements include front and rear first end section cladding elements 330a, 330b, front and rear middle section cladding elements 340a, 340b, and front and rear second end section cladding elements 350a, 350b.

The first end section cladding elements 330a, 330b each include a respective side wall 332a, 332b, a respective bottom wall 334a, 334b, and a respective end wall 336a, 336b.

Similarly, the second end section cladding elements 350a, 350b each include a respective side wall 352a, 352b, a respective bottom wall 354a, 354b, and a respective end wall 356a, 356b.

Somewhat similarly, the middle section cladding elements 340a, 340b each include a respective side wall 342a, 342b and a respective bottom wall 344a, 344b.

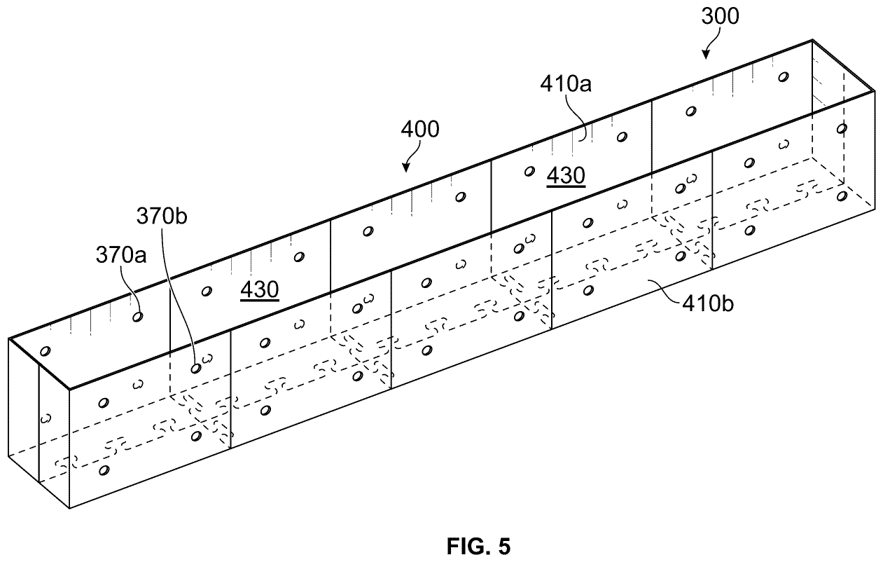

In this exemplary embodiment, each of the rear and front side walls defines at least one opening 370a, 370b, respectively, dimensioned to admit passage of a fastener usable to secure the cladding element to a corresponding structural element. In this exemplary embodiment, openings on opposing front and rear walls are axially aligned to permit passage of a single linear fastener (e.g., threaded rod or bolt) though corresponding openings on both the front and rear walls, if desired, as will be best appreciated from FIG. 5.

In this exemplary embodiment, the bottom walls of each cladding element are configured to define complementary mating structures 360a, 360b, such that each front section cladding element is matable and mechanically interlockable with a corresponding rear section cladding element in an interference fit. In this example, the complementary meting structures 360a, 360b are provided as male tabs and female sockets, although any suitable structures may be used.

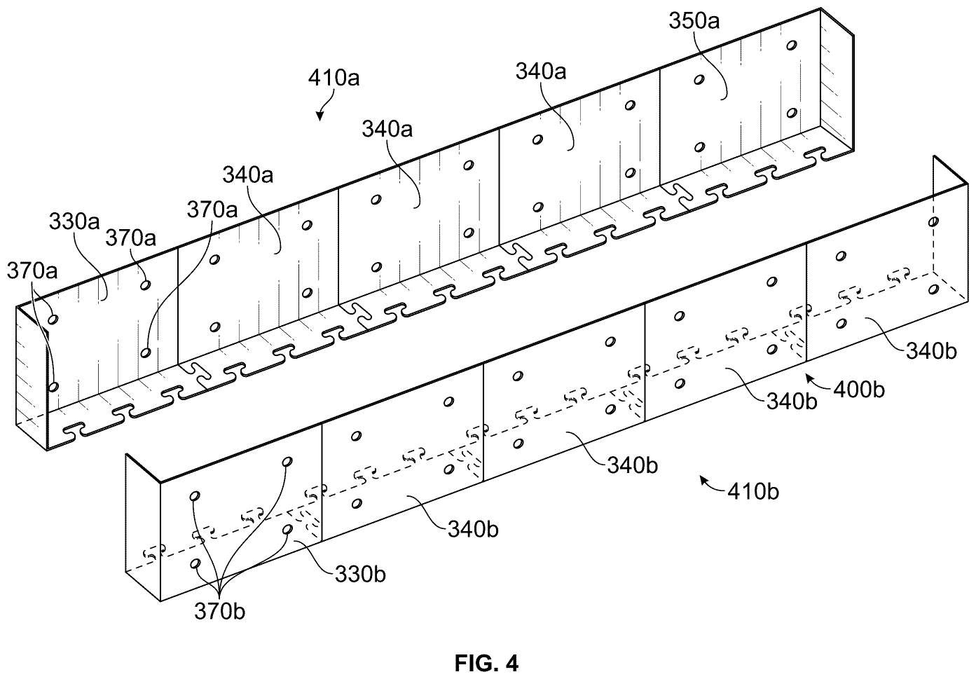

FIG. 4 shows the cladding member elements of FIG. 3 partially assembled into an envelope-type cladding 300 usable as a form 400 for casting of a structural member, in accordance with an exemplary embodiment of the present invention. More particularly, FIG. 3 shows a rear first end cladding element 330a, multiple rear middle section cladding elements 340a, and a rear second end cladding element 350a assembled into a rear half 410a of a casting form 400.

Further, FIG. 4 shows front first end cladding element 330b, multiple front middle section cladding elements 340b, and a front second end cladding element 350b assembled into a front half 410b of the casting 400.

FIG. 5 shows the cladding elements fully assembled into an envelope suitable for at least partially covering a structural member. More particularly, FIG. 5 shows the front and rear halves 410b, 410a mated and interlocked with each other to form. In this embodiment, the cladding member 300 is as an envelope to define a form that is a partially closed form partially enclosing an internal volume, except for an open top/end 430.

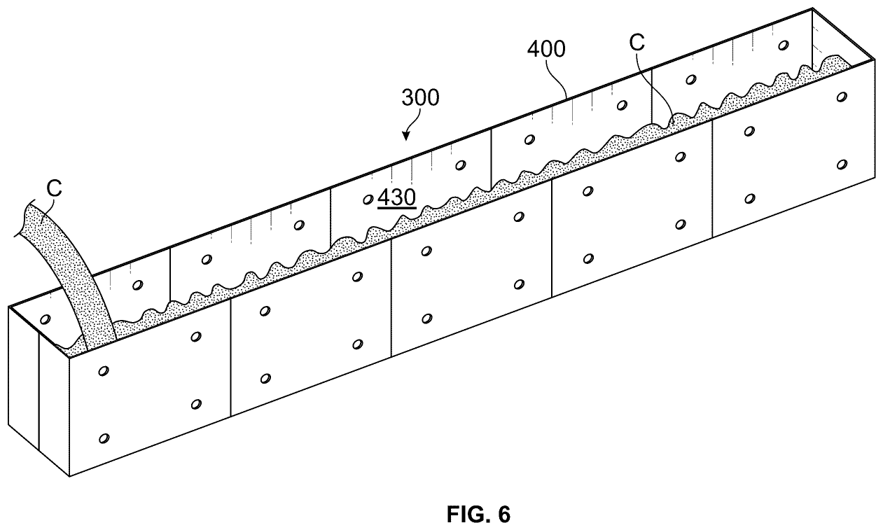

FIG. 6 shows the envelope-type cladding member 300 of FIG. 5 being used as a form 400 to cast a structural member 320, showing pouring of suitable concrete/casting material C into the open top 430 of the exemplary form 400. After pouring, the concrete/casting material C is cured/allowed to cure to form a completed and structurally-sound structural member 320.

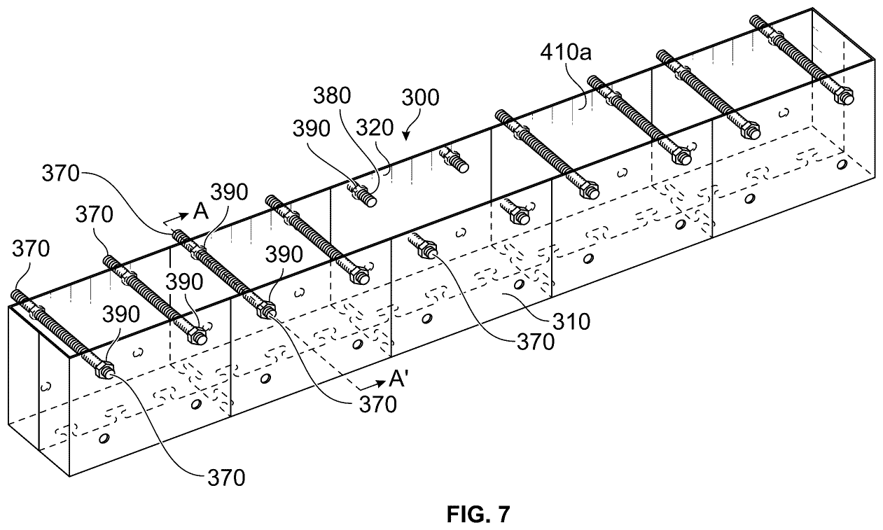

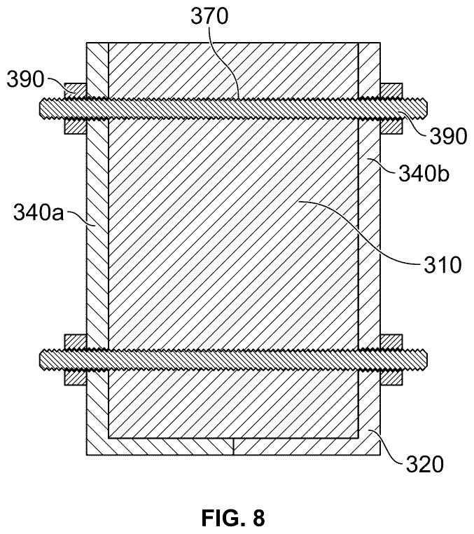

FIG. 7 shows an exemplary bridge cap beam-type infrastructure element 300 after the casting process shown in FIG. 6. As will be appreciated from FIGS. 2C and 7, the exemplary infrastructure element includes a concrete/structural/load-baring structural member 320 to which is joined, in this case releasably joined by way of mechanical fasteners such as threaded rod 370 and/or bolt 380 and complementarily threaded nuts 390, as best shown in FIGS. 7 and 8. Notably, these threaded rods 370 and/or bolts 380, or other suitable fasteners, may be placed in the form and embedded in the structural member 320 during casting. Alternatively, PVC or other tubing may be placed in the form 400 during casting to cause formation of holes/cavities/through-bores in the structural member 320, into which rods/bolts or other fasteners may later be placed to secure the cladding to the structural member. For example, drilling may be used to create holes in the cladding members (e.g., sufficient late after printing to prevent collapse before sufficient curing of the printed cladding member and sufficiently early to avoid cracking after extensive curing, and PVC piping may be used to spanning two opposite cladding member portions.

It should be appreciated that the structural member 320 can be designed initially to determine suitable sizing, shape, thickness, etc. for a given material, and then the cladding member can be designed as a form, and as a removable cladding member made up of multiple cladding elements so as to be readily removable/disassemblable from the structural member, as will be appreciated by those skilled in the art.

Accordingly, a carbon-sequestering infrastructure member may be constructed as described above, using the cladding member as form/mold for casting of the structural member. In other exemplary embodiments, the cladding elements and/or member may be constructed and subsequently attached to a pre-existing structural member, or a subsequently constructed structural member that was not cast in the cladding member. For example, mechanical or other fasteners and/or securing methods may be used to mount carbon-sequestering cladding elements in accordance with the present invention to structural members of infrastructure structures.

Accordingly, infrastructure structures and/or their component structural members may be constructed in a conventional manner, and then carbon-sequestering cladding may be added in accordance with the present invention, or infrastructure structures may be constructed by constructing carbon-sequestering infrastructure elements in accordance with the present invention, and then constructing infrastructure structures using the carbon-sequestering infrastructure elements, in accordance with the present invention. Further, it should be noted that in accordance with the present invention carbon-sequestering cladding may be added to a very broad range of structures/buildings, etc. and thus the term infrastructure and/or infrastructure structure as used herein is intended to be interpreted very broadly, and not in a limiting fashion. For example, cladding in accordance with the present invention may be provided on existing roofs of buildings/structures and/or be incorporated into roof elements (e.g., shingles, beams or other expose surfaces) in accordance with the present invention.

In embodiments in which the carbon-sequestering cladding is releasably attached to the structural members, the cladding will contact ambient/atmospheric air over time, and capture/sequester carbon entrained in the air, e.g., as part of carbon dioxide. This removes the carbon/carbon dioxide from the atmospheric/ambient air, which is desirable. Over time, as the cladding sequesters carbon in the cladding and/or as the bacteria/bio-organisms die and/or the cladding's carbon sequestration capacity otherwise becomes diminished or depleted, it may be desirable to replace the existing cladding currently having diminished carbon-sequestering capacity with replacement cladding currently having a greater carbon-sequestering capacity. This may be achieved in certain embodiments of the present invention by unfastening the mechanical fasteners or otherwise removing the cladding from the structural member, assembling a replacement cladding member to the structural member, and re-fastening the mechanical fastener(s) to secure the replacement cladding member to the structural member. This restores the carbon sequestering capacity of the infrastructure element, and thereby, the infrastructure structure.

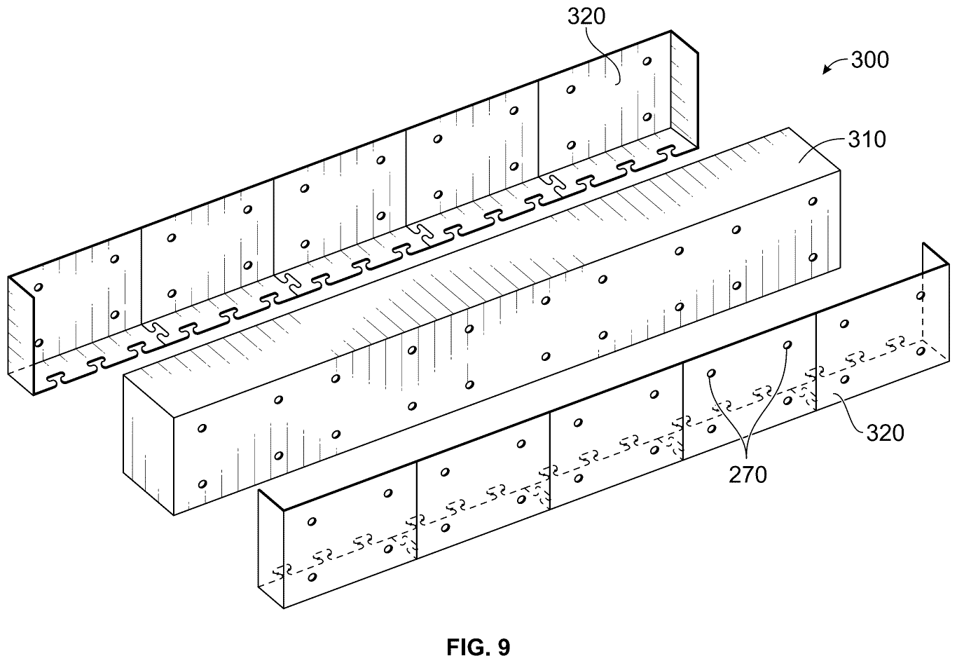

FIG. 9 shows the infrastructure element 300 of FIG. 7 partially disassembled, with an original cladding member 320 (e.g., rear half 410a and front half 410b) removed, e.g., after they have been determined to have a diminished carbon sequestration capacity, e.g., by testing/analysis, by observation, or by passage of time, etc.

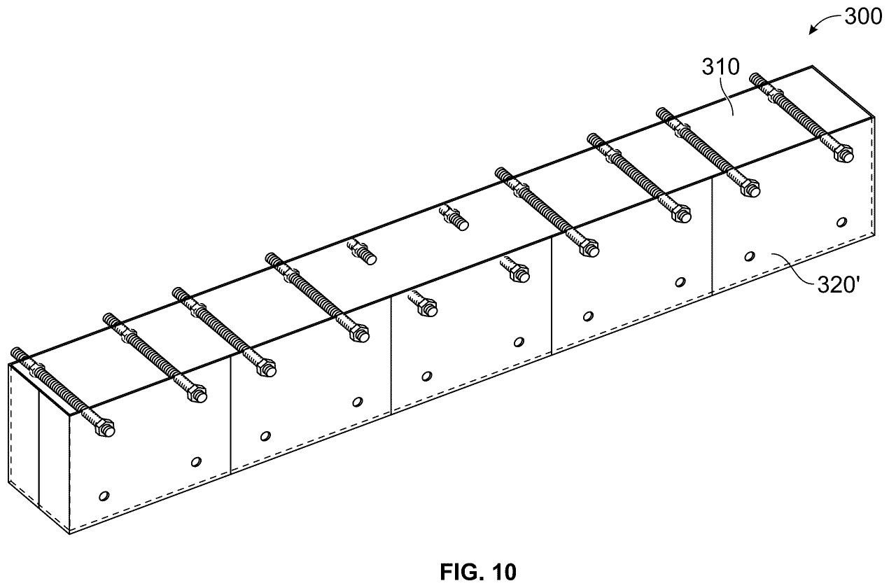

FIG. 10 shows a reassembled infrastructure element 300 similar to that of FIG. 7 but including a replacement cladding member 320′ similarly secured to the structural member 320 by suitable mechanical fasteners. In accordance with the present invention, the replacement cladding member 320′ has a higher carbon sequestration capacity than the original cladding member 320, due to the replacement after prolonged exposures to ambient/atmospheric air and resulting substantial carbon sequestration by the original cladding member 320.

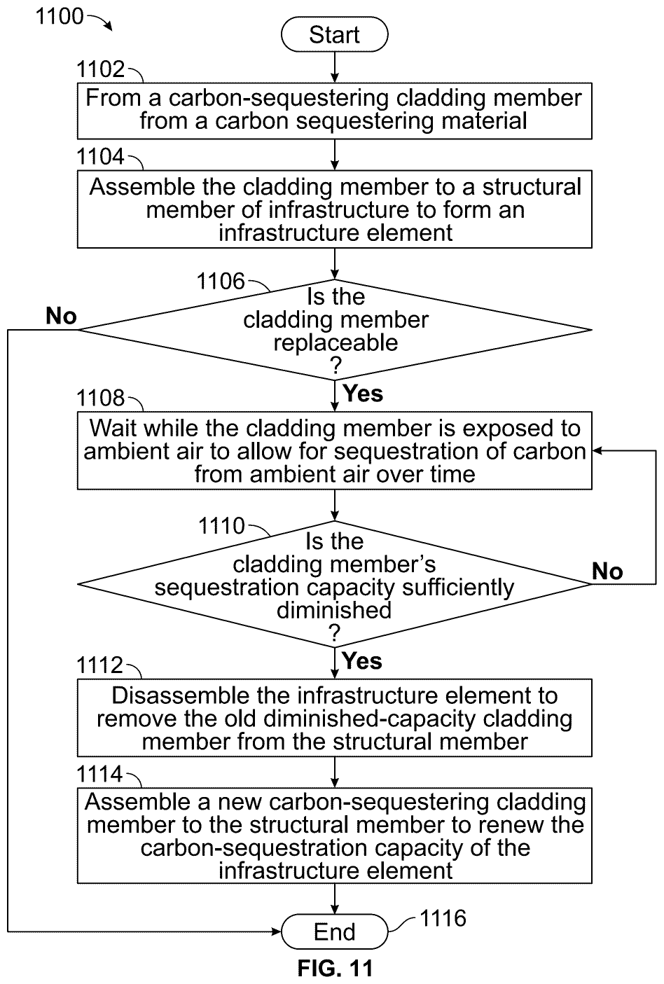

FIG. 11 is a flow diagram illustrating an exemplary method 1100 for use of carbon sequestration construction elements in infrastructure construction. The exemplary method for construction of an infrastructure-type structure including at least one load-bearing element comprises forming a carbon-sequestering cladding member from a carbon sequestering material configured to sequester carbon from air in contact with the carbon-sequestering material, as shown at 1102. By way of example, this may involve using a 3D printing or additive manufacturing technique to manufacture the cladding member, e.g., using concrete, or low-entrained carbon concrete, or another material. In certain embodiments, this may involve designing a structural member to withstand a desired structural load, the structural member having a defined size, shape, configuration for a specified material, and designing a cladding member to have a corresponding size, shape and configuration to at least partial cover or encase the structural member. Further, this step may involve constructing a plurality of discrete cladding elements (e.g., by additive manufacturing techniques), and assembling the discrete cladding elements to form the cladding member.

Next, the exemplary method involves assembling the cladding member to ta structural member of infrastructure to form an infrastructure element, as shown at 1104 in FIG. 11. For example, which may involve assembling multiple discrete cladding elements into a cladding member, casting concrete or other material into a cladding member, using the cladding member as a form, and mechanical fastening or otherwise securing a cladding member to a structural member of an infrastructure structure, before or after construction of an infrastructure structure including the structural member. In certain embodiments, this step may involve constructing an infrastructure structure to include the infrastructure element, and/or the cladding member.

Referring again to FIG. 11, if the cladding member is not readily replaceable, e.g., not readily releasable by mechanical fasteners or the like, then the method may end and the cladding member will sequester carbon from air it comes in contact with, e.g., during the service life of the cladding and/or infrastructure structure, and the method ends, as shown at 1106 and 1116.

If, however, the cladding member is readily replaceable, then the exemplary method involves waiting until the cladding member is exposed to ambient air, as shown at 1108. For example, this may involve waiting for a specific duration of time, to allow for sequestration of carbon from the ambient air over time.

Next, the exemplary method involves determining if the cladding member's carbon sequestration capacity is sufficiently diminished, as shown at 1110. For example, this many involve testing/analysis of the cladding member, observation of the cladding member, and/or simply expiration of a predetermined period of time. If not, then the waiting may continue, as shown at 1108.

If, however, thee cladding member's carbon sequestration capacity is sufficiently diminished, then the exemplary method involves disassembling the infrastructure element to remove the old/existing cladding member having the diminished carbon sequestration capacity from the structural member, as shown at 1112.

Next, the exemplary method involves reassembling the infrastructure element by assembling a new/replacement cladding member to the structural member, and the method ends, as shown at 1114 and 1116. The new/replacement cladding member has a carbon sequestration capacity greater than that of the cladding member having the diminished carbon sequestration capacity.

Accordingly, the exemplary method provides infrastructure structure construction and/or maintenance providing for carbon sequestration, and in certain instances sustained/prolonged carbo sequestration, e.g., by allowing the carbon sequestration capacity of the cladding member, infrastructure element and/or infrastructure structure to be restored, renewed, or otherwise improved relative to continued use of the original cladding member.

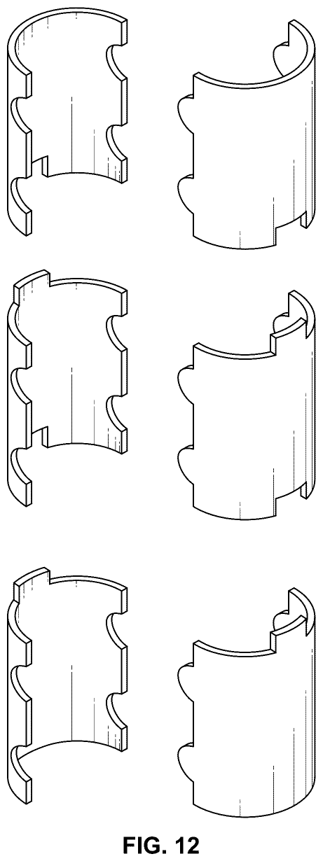

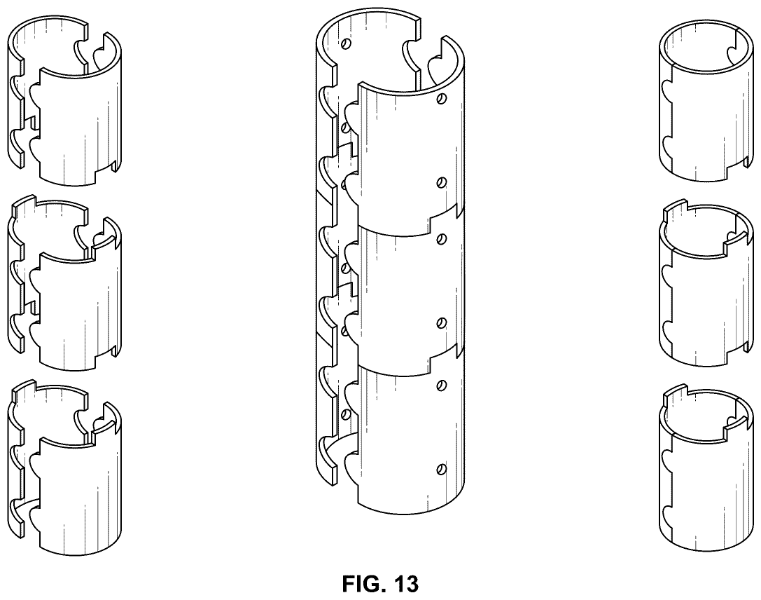

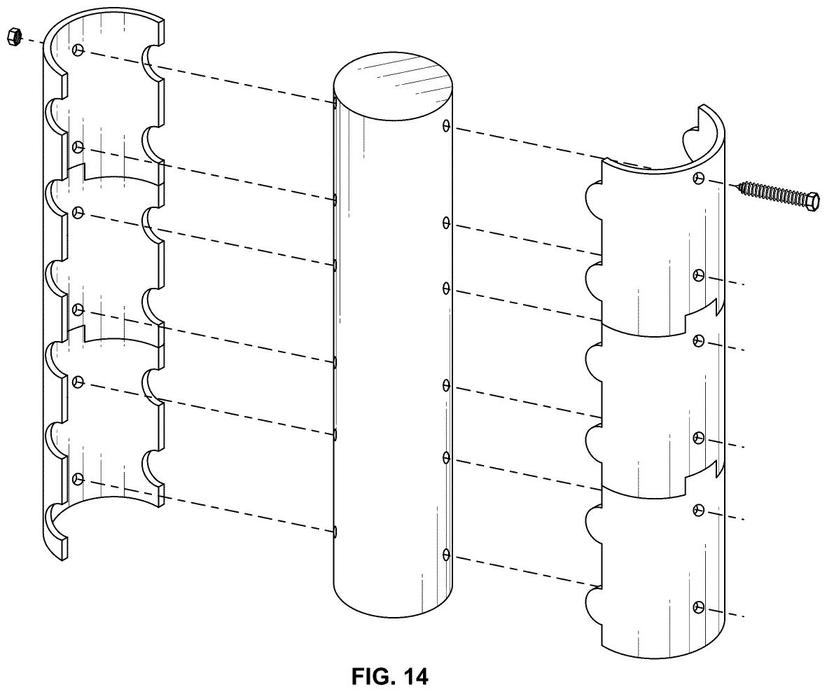

As referred to above, the example above is provided for illustrative purposes only, and is non limiting. By way of further illustrative example, FIG. 12 is a perspective view of exemplary cladding elements of a cladding member 220 for a column-type structural member 200. FIG. 13 shows exemplary cladding elements partial assembled into the cladding member 220. FIG. 14 shown an exploded view of the column-type infrastructure element 200 including the exemplary cladding elements of FIG. 12.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. An infrastructure element usable to construct an infrastructure-type structure, the infrastructure element comprising:
a structural member constructed of a load-bearing material suitable for carrying a desired structural load as part of the structure, said structural member being shaped and dimensioned to bear the desired structural load; and
a cladding member supported on said structural member, said cladding member being constructed of a material configured to sequester carbon from air contacting said cladding member.

2. The infrastructure element of claim 1, wherein said material configured to sequester carbon comprises bacteria operative to sequester carbon from air contacting said cladding member.

3. The infrastructure element of claim 1, wherein said material configured to sequester carbon comprises bio-organisms operative to sequester carbon from air contacting said cladding member.

4. The infrastructure element of claim 1, wherein said material configured to sequester carbon comprises low carbon embodied concrete selected from a first group consisting of bio-polymer concrete, geopolymer concrete and concrete having a high percentage of cement replacement selected from a second group consisting of silica fume, fly ash, and slag.

5. The infrastructure element of claim 1, wherein said material configured to sequester carbon comprises concrete having an average compressive strength in a range of about 1,500 psi to about 2,000 psi.

6. The infrastructure element of claim 1, wherein said load-bearing material comprises low carbon embodied concrete selected from a first group consisting of bio-polymer concrete, geopolymer concrete and concrete having a high percentage of cement replacement selected from a second group consisting of silica fume, fly ash, and slag.

7. The infrastructure element of claim 1, wherein said load-bearing material comprises concrete having an average compressive strength in a range of about 5,000 psi to about 22,000 psi.

8. The infrastructure element of claim 1, wherein said load-bearing material comprises concrete having an average compressive strength in a range of about 5,000 psi to about 22,000 psi for bearing the desired structural load, and wherein said material configured to sequester carbon comprises concrete having an average compressive strength in a range of about 1,500 psi to about 2,000 psi.

9. The infrastructure element of claim 1, wherein said cladding member is permanently bonded to said structural member.

10. The infrastructure element of claim 1, wherein said cladding member is removably attached to said structural member by removable fasteners.

11. The infrastructure element of claim 1, wherein said cladding member is configured as an encasement to fully encapsulate surface area of said structural member.

12. The infrastructure element of claim 1, wherein said cladding member is configured as a shell to no more than partially cover surface area of said structural member.

13. The infrastructure element of claim 1, wherein said cladding member is configured as an envelope defining a partially closed form suitable for casting concrete to form said structural member.

14. The infrastructure element of claim 1, wherein said cladding member comprises a plurality of cladding elements, each of said plurality of cladding elements being configured to mate and mechanically interlock with another of said plurality of cladding elements to collectively form said cladding member.

15. An infrastructure element usable to construct an infrastructure-type structure, the infrastructure element comprising:
a structural member constructed of a load-bearing material suitable for carrying a desired structural load as part of the structure, said structural member being shaped and dimensioned to bear the desired structural load, said load-bearing material comprising low-embodied-carbon concrete having a carbon content in a first range of about 100 kgCO2 eq to about 300 kgCO2 eq and an average compressive strength in a second range of about 5,000 psi to about 22,000 psi; and
a cladding member constructed of a carbon sequestration material configured to sequester carbon from air contacting said cladding member, said carbon sequestration material comprising low-embodied-carbon concrete selected from a first group consisting of bio-polymer concrete, geopolymer concrete and concrete having a high percentage of cement replacement selected from a second group consisting of silica fume, fly ash, and slag, and an average compressive strength in a second range of about 1500 psi to about 2000 psi, and at least one of bacteria and bio-organisms operative to sequester carbon from air contacting said cladding member; and
a plurality of fasteners releasably coupling said cladding member to said structural member.

16. The infrastructure element of claim 16, wherein said cladding member comprises a plurality of cladding elements, each of said plurality of cladding elements being configured to mate and mechanically interlock with another of said plurality of cladding elements to collectively form said cladding member.

17. The infrastructure element of claim 16, said plurality of fasteners comprise:
a plurality of bolts embedded in said structural member; and
a respective nut releasably attached to each of said plurality of bolts.

18. A method for construction of an infrastructure-type structure including at least one load-bearing element, the method comprising:
forming a cladding member from a carbon-sequestering material configured to sequester carbon from air in contact with the carbon-sequestering material;
assembling the cladding member to a structural member adapted to the at least one load-bearing element, to form an infrastructure element usable to construct the infrastructure-type structure.

19. The method of claim 19, wherein forming said cladding member comprises:
constructing a plurality of discreate cladding elements; and
assembling said plurality of discrete cladding elements to form said cladding member.

20. The method of claim 19, wherein forming said cladding member comprises constructing said cladding member of a material comprising at least one of bacteria and bio-organisms operative to sequester carbon from air.

21. The method of claim 19, wherein forming said cladding member comprises constructing said cladding member from a concrete mix material using an additive manufacturing process.

22. The method of claim 19, wherein forming said cladding member comprises constructing said cladding member from a low-embodied-carbon concrete mix material using an additive manufacturing process.

23. The method of claim 19, wherein assembling the cladding member to the structural member comprises attaching the cladding member to an existing structural member.

24. The method of claim 19, wherein assembling the cladding member to the structural member comprises:
constructing the structural member by casting a concrete mix material in a form.

25. The method of claim 19, wherein assembling the cladding member to the structural member comprises:
constructing the structural member by casting a low-embodied-carbon concrete mix material in a form.

26. The method of claim 19, wherein assembling the cladding member to the structural member comprises:
constructing the structural member by casting a concrete mix material in the cladding member.

27. The method of claim 19, wherein assembling the cladding member to the structural member comprises:
removably attaching the cladding member to the structural member using removal mechanical fasteners.

28. The method of claim 19, further comprising:
waiting while the cladding member is exposed to ambient air to allow for sequestration of carbon by the cladding member over time, until the cladding member has a diminished carbon sequestration capacity;
disassembling the infrastructure element to remove the cladding member having the diminished carbon sequestration capacity from the structural member; and
reassembling the infrastructure element by assembling a replacement cladding member to the structural member, the replacement cladding member having a carbon sequestration capacity greater than that of the cladding member having the diminished carbon sequestration capacity.
